(19) United States
(12) Patent Application Publication
(10) Pub. No.: US 2024/0150878 A1
(43) Pub. Date: May 9, 2024

(54) STEEL MATERIAL

(71) Applicant: NIPPON STEEL CORPORATION, Tokyo (JP)

(72) Inventors: Shinya TERAMOTO, Chiyoda-ku, Tokyo (JP); Keisuke CHIBA, Chiyoda-ku, Tokyo (JP); Yutaka NEISHI, Chiyoda-ku, Tokyo (JP)

(21) Appl. No.: 18/548,952

(22) PCT Filed: Mar. 24, 2021
(86) PCT No.: PCT/JP2021/012350

§ 371 Date: Sep. 5, 2023

(51) Int. Cl. C22C 38/24; C22C 38/02; C22C 38/04

(52) U.S. Cl. CPC C22C 38/24; C22C 38/02; C22C 38/04

(57) ABSTRACT

The chemical composition of a steel material according to the present embodiment consists of, in mass %, C: 0.50 to 0.80%, Si: 1.20 to 2.90%, Mn: 0.25 to 1.00%, Cr: 0.40 to 1.90%, V: 0.05 to 0.60%, P: 0.020% or less, S: 0.020% or less, N: 0.0100% or less, Mo: 0 to 0.50%, Nb: 0 to 0.050%, W: 0 to 0.60%, Ni: 0 to 0.50%, Co: 0 to 0.30%, B: 0 to 0.0050%, Cu: 0 to 0.050%, Al: 0 to 0.0050%, and Ti: 0 to 0.050%, with the balance being Fe and impurities. In the microstructure of the steel material, an area fraction of pearlite is 90% or more, and in ferrite in the pearlite, a volumetric number density of V-based precipitates having a maximum diameter of 2 to 20 nm is 3000 to 80000 pieces/μm³.

### TECHNICAL FIELD

The present invention relates to a steel material, and more particularly relates to a steel material which serves as a starting material for a spring such as a damper spring or a valve spring.

### BACKGROUND ART

Springs are widely used in automobiles and general machinery. Among the springs used in automobiles and general machinery, damper springs absorb impacts from the outside and vibrations. A damper spring is used, for example, in a torque converter that transmits the motive power of an automobile to the transmission. A damper spring is required to have high fatigue strength. Further, among springs used in automobiles and general machinery, a valve spring regulates the opening and closing of an internal valve of the automobile or general machinery. A valve spring is used, for example, to control the opening and closing of an air supply valve of an internal combustion engine (engine) of an automobile. Therefore, similarly to a damper spring, a valve spring is also required to have high fatigue strength.

A process for producing a spring as typified by a damper spring or a valve spring or the like is as follows. A steel material (wire rod) that will serve as the starting material for the spring is prepared. The steel material is subjected to a shaving (peeling) treatment. Here, the term “shaving treatment” refers to a process in which the steel material (wire rod) is passed through a shaving die to thereby shave (peel) off the entire surface (peripheral surface) of the steel material. By performing the shaving treatment, surface defects and a decarburizing layer on the surface of the steel material are removed.

The steel material after the shaving treatment is subjected to wire drawing to form a steel wire. A thermal refining treatment (quenching and tempering) is performed on the steel wire. The steel wire after the thermal refining treatment is subjected to cold coiling to produce an intermediate steel material in a coil shape. The intermediate steel material is subjected to stress relieving. The intermediate steel material after the stress relieving is, as necessary, subjected to a case hardening heat treatment (nitriding or the like). The intermediate steel material after the stress relieving or the case hardening heat treatment is subjected to shot peening to impart compressive residual stress to the outer layer. A spring is produced by the above production process.

Technology relating to such kind of steel material which serves as a starting material for a spring is proposed in Japanese Patent Application Publication No. 7-173577 (Patent Literature 1) and Japanese Patent Application Publication No. 2007-327084 (Patent Literature 2).

A steel material for a spring disclosed in Patent Literature 1 contains, in mass %, C: 0.3 to 0.6%, Si: 1.0 to 3.0%, Mn: 0.1 to 0.5%, and Cr: 0.5 to 1.5%, and further contains Ni: 1.0% or less (not including 0) and/or Mo: 0.1 to 0.5%, with the balance being Fe and unavoidable impurities. In addition, in this steel material, FP (=(0.23[C]+0.1)×(0.7[Si]+1)×(3.5[Mn]+1)×(2.2[Cr]+1)×(0.4[Ni]+1)×(3[Mo]+1)) is 2.5 to 4.5. It is stated in Patent Literature 1 that, as a result, the aforementioned steel material has a high strength of 1900 MPa or more after quenching and tempering, and also has excellent corrosion resistance.

A wire rod disclosed in Patent Literature 2 consists of, in mass %, C: 0.6 to 1.1%, Si: 0.1 to 2.0%, Mn: 0.1 to 1%, P: 0.020% or less (not including 0%), S: 0.020% or less (not including 0%), N: 0.006% or less (not including 0%), Al: 0.03% or less (not including 0%), and O: 0.003% or less (not including 0%), with the balance being Fe and unavoidable impurities. In addition, this wire rod has a pearlite structure in which an area fraction of second-phase ferrite is 11.0% or less, and a pearlite lamellar spacing is 120 μm or more. It is stated in Patent Literature 2 that by being composed as described above, this wire rod is insusceptible to wire breakage irrespective of an increase in the wire-drawing rate and an increase in the reduction of area, and can also extend the life of a die used for wire drawing.

### CITATION LIST

### Patent Literature

Patent Literature 1: Japanese Patent Application Publication No. 7-173577
Patent Literature 2: Japanese Patent Application Publication No. 2007-327084

### SUMMARY OF INVENTION

### Technical Problem

In this connection, as described above, a steel material which will serve as a starting material for a spring is subjected to a shaving treatment (peeling) during the process of producing the spring. In this case, surface defects induced by shaving (hereunder, referred to as “shaving-induced surface defects”) such as a “burr”, a “gouge” or a “crack” may sometimes occur on the surface of the steel material after the shaving treatment. Here, the term “burr” refers to a surface defect that occurs due to a part of a chip generated on the steel material surface during the shaving treatment remaining on the steel material surface. The term “gouge” refers to a surface defect that occurs due to a part of the steel material surface near the root of a chip being torn off when the chip separates from the steel material surface. The term “crack” refers to a surface defect that occurs due to a crack being generated in a part of the steel material surface near the root of a chip when the chip separates from the steel material surface. A steel material surface on which a shaving-induced surface defect occurred has reduced smoothness and is in a state in which surface deterioration has occurred. In a spring produced using a steel material in which surface deterioration has occurred on the surface, the fatigue strength decreases. Therefore, in a steel material that will serve as a starting material for a spring, there is a need to suppress surface deterioration of the steel material surface after undergoing a shaving treatment.

In the aforementioned Patent Literatures 1 and 2 there is no disclosure of any kind regarding a technique for suppressing surface deterioration of a steel material after a shaving treatment.

An objective of the present disclosure is to provide a steel material capable of suppressing surface deterioration on a surface when a shaving treatment is performed.

### Solution to Problem

A steel material of the present embodiment has a chemical composition consisting of, in mass %,
C: 0.50 to 0.80%,
Si: 1.20 to 2.90%,
Mn: 0.25 to 1.00%,
Cr: 0.40 to 1.90%,
V: 0.05 to 0.60%,
P: 0.020% or less,
S: 0.020% or less,
N: 0.0100% or less,
Mo: 0 to 0.50%,
Nb: 0 to 0.050%,
W: 0 to 0.60%,
Ni: 0 to 0.50%,
Co: 0 to 0.30%,
B: 0 to 0.0050%,
Cu: 0 to 0.050%,
Al: 0 to 0.0050%, and
Ti: 0 to 0.050%,
with the balance being Fe and impurities,
wherein:
in a microstructure of the steel material, an area fraction of pearlite is 90% or more, and
in ferrite in the pearlite,
a volumetric number density of V-based precipitates having a maximum diameter of 2 to 20 nm is 3000 to 80000 pieces/μm³.

### Advantageous Effect of Invention

The steel material according to the present disclosure is capable of suppressing surface deterioration of the steel material surface in a case where a shaving treatment is performed.

### BRIEF DESCRIPTION OF DRAWINGS

FIG. 1 is one example of a transmission electron microscope (TEM) image of ferrite in pearlite of a thin foil sample.

FIG. 2 is a flowchart illustrating a process for producing the steel material of the present embodiment.

FIG. 3 is a view illustrating one example of a thermal history of the steel material in a finish rolling step in FIG. 2.

FIG. 4 is a view illustrating a continuous cooling transformation curve (CCT curve) in a cooling step for cooling the steel material of the present embodiment illustrated in FIG. 3.

FIG. 5 is a flowchart illustrating a process for producing a spring using the steel material of the present embodiment.

### DESCRIPTION OF EMBODIMENT

The present inventors initially conducted studies regarding the chemical composition and microstructure of a steel material which is suitable as a starting material for springs typified by damper springs and valve springs and the like. A steel material that has a chemical composition with which the fatigue strength of a spring is obtained in a case where the spring is produced using the steel material as a starting material is suitable as a steel material for spring applications. In addition, a structure that allows the steel material to be shaved in a shaving treatment (peeling) during a process for producing a spring is suitable for a steel material for spring applications. As a result of such studies, the present inventors considered that if the chemical composition of the steel material consists of, in mass %, C: 0.50 to 0.80%, Si: 1.20 to 2.90%, Mn: 0.25 to 1.00%, Cr: 0.40 to 1.90%, V: 0.05 to 0.60%, P: 0.020% or less, S: 0.020% or less, N: 0.0100% or less, Mo: 0 to 0.50%, Nb: 0 to 0.050%, W: 0 to 0.60%, Ni: 0 to 0.50%, Co: 0 to 0.30%, B: 0 to 0.0050%, Cu: 0 to 0.050%, Al: 0 to 0.0050%, and Ti: 0 to 0.050%, with the balance being Fe and impurities, and an area fraction of pearlite in the microstructure is 90% or more, the steel material will be suitable for spring applications.

The present inventors then conducted studies with respect to the steel material having the aforementioned chemical composition and microstructure with respect to means for suppressing surface deterioration on the steel material surface after performing a shaving treatment. As a result, the present inventors obtained the following finding.

As described above, a shaving treatment (peeling) is a treatment in which the entire surface of a steel material (wire rod) is peeled off (cut) using a shaving die. Because the entire steel material surface is peeled off in the shaving treatment, scale and a decarburizing layer on the steel material surface can be removed, and defects such as rolling surface defects can also be removed. As a result, the steel material surface after the shaving treatment is smooth. However, if the steel material surface is not cut smoothly in the shaving treatment, shaving-induced surface defects such as burrs, gouges, or cracks will occur on the steel material surface after the shaving treatment. The shaving-induced surface defects decrease the smoothness of the steel material surface, and cause surface deterioration on the steel material surface. Therefore, the present inventors investigated a mechanism by which a steel material surface is cut during the shaving treatment. As a result, the present inventors obtained the following finding.

During a shaving treatment, the surface of the steel material is cut by a shaving die. The steel material portion that has been cut is broken away from the steel material surface as chips. At such time, if it is difficult for a chip cut from the surface of the steel material by the shaving die to be broken away from the steel material surface, during the shaving treatment, a part of the chip will remain on the steel material surface, or a portion of the steel material near a root of the chip will be gouged, or a crack will occur in the steel material surface near the root of the chip. Such parts of chips that remain on the surface, or gouges or cracks that occur at the root of chips become shaving-induced surface defects, and cause surface deterioration of the steel material surface. Therefore, the present inventors considered that, during a shaving treatment, if chips that are generated by cutting with a shaving die can be easily broken away from the steel material surface, the chips will be broken into short pieces. If the chips are broken into short pieces, it will be easy to readily remove the short chips from the steel material surface. Consequently, the occurrence of a situation in which a part of a chip remains on the steel material surface, or a steel material portion near the root of a chip is gouged, or a crack occurs in the steel material surface near the root of a chip can be suppressed. As a result, the occurrence of shaving-induced surface defects will be suppressed, surface deterioration of the steel material surface will be suppressed, and the smoothness of the steel material surface can be secured.

The present inventors therefore conducted further studies regarding means capable of breaking chips into short pieces in the shaving treatment, with respect to the steel material having the chemical composition and microstructure described above.

It is generally known that MnS that is an inclusion in a steel material increases the machinability of the steel material. Therefore, the present inventors initially considered suppressing surface deterioration of the steel material surface after the shaving treatment by controlling the morphology of MnS that is an inclusion in the steel material.

However, in a spring, MnS that is an inclusion may lower the fatigue characteristics. Thus, the present inventors considered that it is not suitable to utilize MnS in the steel material to suppress surface deterioration of the steel material surface after shaving. Therefore, the present inventors considered suppressing surface deterioration of the steel material surface after the shaving treatment by use of other means which is different from utilizing MnS.

Here, the present inventors focused their attention on the microstructure of the steel material that will serve as the starting material for a spring. As described above, the microstructure of the steel material that will serve as the starting material for a spring is a structure mainly composed of pearlite in which the area fraction of pearlite is 90% or more. Pearlite is constituted by ferrite and cementite. Since ferrite is soft in comparison to cementite, ferrite is more difficult to separate than cementite during the shaving treatment. Therefore, the present inventors focused their attention on ferrite in the pearlite structure, and conducted studies regarding means for making ferrite easy to separate.

As a result of such studies, the present inventors conceived of utilizing precipitates which precipitate in ferrite, and not inclusions such as MnS, to make ferrite easy to separate during the shaving treatment. Further, the present inventors considered that if a large number of nano-sized fine V-based precipitates are intentionally formed in the ferrite, the ferrite will become easy to separate during the shaving treatment. Here, the term “fine V-based precipitates” refers to precipitates which contain V and which are precipitates having a maximum diameter of 2 to 20 nm in an observation visual field observed using a TEM (transmission electron microscope) which is described later. The precipitates containing V are, for example, V carbides and V carbo-nitrides and the like.

V-based precipitates can be formed in ferrite by interphase boundary precipitation. Further, V-based precipitates are extremely fine in comparison to MnS. Specifically, even a fine MnS particle has a size of about 1 μm, whereas V-based precipitates can be formed with a size of about 2 to 20 nm. If the size of the precipitates is small, they are unlikely to become starting points of fatigue fracture. Hence, it is difficult for V-based precipitates to reduce the fatigue strength of a spring. On the other hand, if a large number of V-based precipitates are formed in the ferrite, during a peeling treatment, it will be easier for the ferrite to break into short pieces due to the V-based precipitates. It is considered that, as a result, it will be difficult for shaving-induced surface defects such as residual parts of chips, gouges, or cracks to occur.

It is considered that, in addition, V-based precipitates can also suppress the occurrence of wear of the shaving die. The hardness of V-based precipitates is high. During the shaving treatment, some of the V-based precipitates included in the chips adhere to a cutting edge of the shaving die. The adhered V-based precipitates increase the wear resistance of the cutting edge of the shaving die. If the wear resistance of the cutting edge of the shaving die is increased, the cutting force (shaving force) of the shaving die can be maintained. Therefore, the ease with which chips can be broken away from the steel material surface can also be maintained.

That is, by causing a large number of V-based precipitates to form in the ferrite, not only can the ease with which chips are broken away from the steel material itself be increased, but the ease with which chips are broken away can also be increased due to the wear resistance of the cutting edge of the shaving die being maintained. It is considered that, as a result, surface deterioration of the steel material after the shaving treatment can be markedly suppressed.

Based on the technical idea described above, the present inventors conducted further detailed studies regarding the volumetric number density of V-based precipitates in the steel material which can sufficiently suppress surface deterioration of the steel material in the shaving treatment. As a result, the present inventors discovered that in the steel material in which the content of each element in the chemical composition is within the range described above, and the area fraction of pearlite in the microstructure is 90% or more, if the volumetric number density of V-based precipitates having a maximum diameter of 2 to 20 nm in ferrite in the pearlite is 3000 to 80000 pieces/μm³, surface deterioration of the steel material after the shaving treatment can be sufficiently suppressed.

Although the mechanism described above is an assumption, it has been demonstrated by the Examples which are described later that if the volumetric number density of V-based precipitates having a maximum diameter of 2 to 20 nm in the ferrite in the pearlite is 3000 to 80000 pieces/μm³, surface deterioration of the steel material after the shaving treatment is sufficiently suppressed.

The steel material of the present embodiment was completed based on the technical idea described above. The steel material according to the present embodiment is as follows.

[1]

A steel material having a chemical composition consisting of, in mass %,
C: 0.50 to 0.80%,
Si: 1.20 to 2.90%,
Mn: 0.25 to 1.00%,
Cr: 0.40 to 1.90%,
V: 0.05 to 0.60%,
P: 0.020% or less,
S: 0.020% or less,
N: 0.0100% or less,
Mo: 0 to 0.50%,
Nb: 0 to 0.050%,
W: 0 to 0.60%,
Ni: 0 to 0.50%,
Co: 0 to 0.30%,
B: 0 to 0.0050%,
Cu: 0 to 0.050%,
Al: 0 to 0.0050%, and
Ti: 0 to 0.050%,
with the balance being Fe and impurities,
wherein:
in a microstructure of the steel material, an area fraction of pearlite is 90% or more; and
in ferrite in the pearlite,
a volumetric number density of V-based precipitates having a maximum diameter of 2 to 20 nm is 3000 to 80000 pieces/μm³.

[2]

The steel material according to [1], wherein:
the chemical composition contains one or more kinds selected from a group consisting of:
Mo: 0.01 to 0.50%,
Nb: 0.001 to 0.050%,
W: 0.01 to 0.60%,
Ni: 0.01 to 0.50%,
Co: 0.01 to 0.30%, and
B: 0.0001 to 0.0050%.

Hereunder, the steel material of the present embodiment is described in detail. The symbol “%” in relation to an element means mass % unless otherwise noted.

[Chemical Composition of Steel Material]

The chemical composition of the steel material contains the following elements.

C: 0.50 to 0.80%

Carbon (C) increases the fatigue strength of a spring produced using the steel material as a starting material. If the content of C is less than 0.50%, even if the contents of other elements are within the range of the present embodiment, the aforementioned effect will not be sufficiently obtained. On the other hand, if the content of C is more than 0.80%, even if the contents of other elements are within the range of the present embodiment, coarse cementite will form. Coarse cementite will reduce the ductility of the steel material. Coarse cementite will also reduce the fatigue strength of a spring produced using the steel material as a starting material. Therefore, the content of C is to be 0.50 to 0.80%. A preferable lower limit of the content of C is 0.51%, more preferably is 0.52%, further preferably is 0.53%, and further preferably is 0.54%. A preferable upper limit of the content of C is 0.79%, more preferably is 0.78%, further preferably is 0.76%, further preferably is 0.74%, further preferably is 0.72%, further preferably is 0.70%, and further preferably is 0.68%.

Si: 1.20 to 2.90%

Silicon (Si) increases the fatigue strength of a spring produced using the steel material as a starting material. Si also deoxidizes the steel. In addition, Si increases the temper softening resistance of the steel material. Therefore, even after a thermal refining treatment (quenching and tempering) is performed in the process for producing the spring, the fatigue strength of the spring can be maintained at a high level. If the content of Si is less than 1.20%, even if the contents of other elements are within the range of the present embodiment, the aforementioned effects will not be sufficiently obtained. On the other hand, if the content of Si is more than 2.90%, even if the contents of other elements are within the range of the present embodiment, the ductility of the steel material that serves as the starting material for the spring will excessively decrease. In addition, the fatigue strength of the spring produced using the steel material as a starting material will decrease. Therefore, the content of Si is to be 1.20 to 2.90%. A preferable lower limit of the content of Si is 1.25%, more preferably is 1.30%, further preferably is 1.35%, further preferably is 1.40%, further preferably is 1.45%, further preferably is 1.50%, further preferably is 1.55%, and further preferably is 1.60%. A preferable upper limit of the content of Si is 2.85%, more preferably is 2.80%, further preferably is 2.75%, further preferably is 2.70%, further preferably is 2.65%, and further preferably is 2.60%.

Mn: 0.25 to 1.00%

Manganese (Mn) increases the hardenability of the steel material, and increases the fatigue strength of a spring produced using the steel material as a starting material. If the content of Mn is less than 0.25%, even if the contents of other elements are within the range of the present embodiment, the aforementioned effect will not be sufficiently obtained. On the other hand, if the content of Mn is more than 1.00%, even if the contents of other elements are within the range of the present embodiment, during the process for producing a spring, the strength of the steel material will become excessively high and the workability of the steel material will decrease. Therefore, the content of Mn is to be 0.25 to 1.00%. A preferable lower limit of the content of Mn is 0.28%, more preferably is 0.30%, further preferably is 0.35%, further preferably is 0.40%, further preferably is 0.45%, further preferably is 0.50%, and further preferably is 0.55%. A preferable upper limit of the content of Mn is 0.95%, more preferably is 0.90%, further preferably is 0.85%, further preferably is 0.80%, and further preferably is 0.75%.

Cr: 0.40 to 1.90%

Chromium (Cr) increases the hardenability of the steel material, and increases the fatigue strength of a spring produced using the steel material as a starting material. If the content of Cr is less than 0.40%, even if the contents of other elements are within the range of the present embodiment, the aforementioned effect will not be sufficiently obtained. On the other hand, if the content of Cr is more than 1.90%, even if the contents of other elements are within the range of the present embodiment, coarse Cr carbides will excessively form. Coarse Cr carbides will reduce the fatigue strength of the spring. Therefore, the content of Cr is to be 0.40 to 1.90%. A preferable lower limit of the content of Cr is 0.45%, more preferably is 0.50%, further preferably is 0.55%, further preferably is 0.60%, further preferably is 0.65%, further preferably is 0.70%, further preferably is 0.75%, and further preferably is 0.80%. A preferable upper limit of the content of Cr is 1.85%, more preferably is 1.80%, further preferably is 1.75%, further preferably is 1.70%, further preferably is 1.65%, and further preferably is 1.60%.

V: 0.05 to 0.60%

Vanadium (V) combines with C and/or N to form V-based precipitates having a maximum diameter of 2 to 20 nm in the ferrite of pearlite. The V-based precipitates make it easy to break apart ferrite during the shaving treatment. Therefore, the V-based precipitates make it easy to break chips into short pieces during the shaving treatment. As a result, surface deterioration of the steel material surface after the shaving treatment is suppressed, and the smoothness of the steel material surface increases. If the content of V is less than 0.05%, even if the contents of other elements are within the range of the present embodiment, the aforementioned effect will not be sufficiently obtained. On the other hand, if the content of V is more than 0.60%, even if the contents of other elements are within the range of the present embodiment, a large number of coarse V-based precipitates having a maximum diameter of more than 20 nm will form in the steel material. The coarse V-based precipitates will reduce the fatigue strength of the spring. Therefore, the content of V is to be 0.05 to 0.60%. A preferable lower limit of the content of V is 0.06%, more preferably is 0.07%, further preferably is 0.08%, further preferably is 0.10%, further preferably is 0.15%, further preferably is 0.17%, further preferably is 0.18%, and further preferably is 0.20%. A preferable upper limit of the content of V is 0.58%, more preferably is 0.57%, further preferably is 0.55%, further preferably is 0.53%, further preferably is 0.50%, further preferably is 0.45%, further preferably is 0.40%, further preferably is 0.35%, and further preferably is 0.30%.

P: 0.020% or Less

Phosphorus (P) is an impurity. P segregates at grain boundaries, and reduces the fatigue strength of a spring produced using the steel material as a starting material. Therefore, the content of P is to be 0.020% or less. A preferable upper limit of the content of P is 0.018%, more preferably is 0.016%, further preferably is 0.014%, further preferably is 0.012%, and further preferably is 0.010%. The content of P is preferably as low as possible, and the content of P of 0% is the most preferable. However, excessively reducing the content of P will raise the production cost. Therefore, when taking into consideration normal industrial production, a preferable lower limit of the content of P is more than 0%, more preferably is 0.001%, further preferably is 0.002%, and further preferably is 0.003%.

S: 0.020% or Less

Sulfur (S) is an impurity. S segregates at grain boundaries similarly to P, and also combines with Mn to form MnS, and thus reduces the fatigue strength of a spring produced using the steel material. Therefore, the content of S is to be 0.020% or less. A preferable upper limit of the content of S is 0.018%, more preferably is 0.016%, further preferably is 0.014%, further preferably is 0.012%, and further preferably is 0.010%. The content of S is preferably as low as possible, and the content of S of 0% is the most preferable. However, excessively reducing the content of S will raise the production cost. Therefore, when taking into consideration normal industrial production, a preferable lower limit of the content of S is more than 0%, more preferably is 0.001%, further preferably is 0.002%, and further preferably is 0.003%.

N: 0.0100% or Less

Nitrogen (N) is an impurity. N combines with Al or Ti to form AlN or TiN, which reduces the fatigue strength of a spring produced using the steel material. Therefore, the content of N is to be 0.0100% or less. A preferable upper limit of the content of N is 0.0095%, more preferably is 0.0090%, further preferably is 0.0085%, further preferably is 0.0080%, further preferably is 0.0075%, further preferably is 0.0070, further preferably is 0.0065%, and further preferably is 0.0060%. The content of N is preferably as low as possible, and the content of N of 0% is the most preferable. However, excessively reducing the content of N will raise the production cost. Therefore, a preferable lower limit of the content of N is more than 0%, more preferably is 0.0001%, further preferably is 0.0003%, further preferably is 0.0005%, further preferably is 0.0007%, and further preferably is 0.0010%.

The balance in the chemical composition of the steel material according to the present embodiment is Fe and impurities. Here, the term “impurities” refers to elements which, during industrial production of the steel material, are mixed in from ore or scrap that is used as a raw material, or from the production environment or the like, and which are allowed within a range that does not adversely affect the steel material of the present embodiment.

[Regarding Optional Elements]

The chemical composition of the steel material according to the present embodiment may also contain one or more kinds selected from the group consisting of Mo, Nb, W, Ni, Co and B in lieu of a part of Fe. These elements are optional elements, and each of these elements increases the fatigue strength of a spring produced using the steel material of the present embodiment.

Mo: 0 to 0.50%

Molybdenum (Mo) is an optional element, and need not be contained. That is, the content of Mo may be 0%. When contained, that is, when the content of Mo is more than 0%, Mo increases the hardenability of the steel material, and increases the fatigue strength of a spring produced using the steel material as a starting material. Mo also increases the temper softening resistance of the steel material. Therefore, even after the thermal refining treatment is performed in a process for producing a spring, the fatigue strength of the spring can be maintained at a high level. If even a small amount of Mo is contained, the aforementioned effect will be obtained to a certain extent. However, if the content of Mo is more than 0.50%, even if the contents of other elements are within the range of the present embodiment, the strength of the steel material to serve as the starting material for a spring will become excessively high and the workability of the steel material will decrease. Therefore, the content of Mo is to be 0 to 0.50%, and when Mo is contained, the content of Mo is to be within the range of more than 0 to 0.50%. A preferable lower limit of the content of Mo is 0.01%, more preferably is 0.05%, and further preferably is 0.10%. A preferable upper limit of the content of Mo is 0.45%, more preferably is 0.40%, further preferably is 0.35%, and further preferably is 0.30%.

Nb: 0 to 0.050%

Niobium (Nb) is an optional element, and need not be contained. That is, the content of Nb may be 0%. When contained, that is, when the content of Nb is more than 0%, Nb combines with C and/or N to form carbides or carbo-nitrides (hereunder, referred to as “Nb carbo-nitrides and the like”). The Nb carbo-nitrides and the like refine austenite grains. Therefore, the fatigue strength of a spring produced using the steel material increases. If even a small amount of Nb is contained, the aforementioned effect will be obtained to a certain extent. However, if the content of Nb is more than 0.050%, even if the contents of other elements are within the range of the present embodiment, coarse Nb carbo-nitrides and the like will form. The coarse Nb carbo-nitrides and the like will reduce the fatigue strength of the spring. Therefore, the content of Nb is to be 0 to 0.050%, and when Nb is contained, the content of Nb is to be within the range of more than 0% to 0.050%. A preferable lower limit of the content of Nb is 0.001%, more preferably is 0.005%, and further preferably is 0.010%. A preferable upper limit of the content of Nb is 0.045%, more preferably is 0.040%, further preferably is 0.035%, further preferably is 0.030%, and further preferably is 0.025%.

W: 0 to 0.60%

Tungsten (W) is an optional element, and need not be contained. That is, the content of W may be 0%. When contained, that is, when the content of W is more than 0%, W increases the hardenability of the steel material, and increases the fatigue strength of a spring produced using the steel material. W also increases the temper softening resistance of the steel material. Therefore, even after the thermal refining treatment is performed in the process for producing a spring, the fatigue strength of a spring produced using the steel material is maintained at a high level. If even a small amount of W is contained, the aforementioned effect will be obtained to a certain extent. However, if the content of W is more than 0.60%, even if the contents of other elements are within the range of the present embodiment, the strength of the steel material will become excessively high and the workability of the steel material will decrease. Therefore, the content of W is to be 0 to 0.60%, and when W is contained, the content of W is to be within the range of more than 0 to 0.60%. A preferable lower limit of the content of W is 0.01%, more preferably is 0.05%, and further preferably is 0.10%. A preferable upper limit of the content of W is 0.55%, more preferably is 0.50%, further preferably is 0.45%, further preferably is 0.40%, further preferably is 0.35%, and further preferably is 0.30%.

Ni: 0 to 0.50%

Nickel (Ni) is an optional element, and need not be contained. That is, the content of Ni may be 0%. When contained, that is, when the content of Ni is more than 0%, Ni increases the hardenability of the steel material, and increases the fatigue strength of a spring produced using the steel material. If even a small amount of Ni is contained, the aforementioned effect will be obtained to a certain extent. However, if the content of Ni is more than 0.50%, even if the contents of other elements are within the range of the present embodiment, the strength of the steel material will excessively increase and the workability of the steel material will decrease. Therefore, the content of Ni is to be 0 to 0.50%, and when Ni is contained, the content of Ni is to be within the range of more than 0 to 0.50%. A preferable lower limit of the content of Ni is 0.01%, more preferably is 0.02%, further preferably is 0.03%, further preferably is 0.05%, and further preferably is 0.10%. A preferable upper limit of the content of Ni is 0.45%, more preferably is 0.40%, and further preferably is 0.35%.

Co: 0 to 0.30%

Cobalt (Co) is an optional element, and need not be contained. That is, the content of Co may be 0%. When contained, that is, when the content of Co is more than 0%, Co increases the temper softening resistance of the steel material. Therefore, even after the thermal refining treatment is performed in the process for producing a spring, the fatigue strength of a spring produced using the steel material is maintained at a high level. If even a small amount of Co is contained, the aforementioned effect will be obtained to a certain extent. However, if the content of Co is more than 0.30%, even if the contents of other elements are within the range of the present embodiment, the strength of the steel material will become excessively high and the workability of the steel material will decrease. Therefore, the content of Co is to be 0 to 0.30%, and when Co is contained, the content of Co is to be within the range of more than 0 to 0.30%. A preferable lower limit of the content of Co is 0.01%, more preferably is 0.05%, and further preferably is 0.10%. A preferable upper limit of the content of Co is 0.28%, more preferably is 0.26%, further preferably is 0.24%, further preferably is 0.22%, and further preferably is 0.20%.

B: 0 to 0.0050%

Boron (B) is an optional element, and need not be contained. That is, the content of B may be 0%. When contained, that is, when the content of B is more than 0%, B increases the hardenability of the steel material and increases the fatigue strength of a spring produced using the steel material. If even a small amount of B is contained, the aforementioned effect will be obtained to a certain extent. However, if the content of B is more than 0.0050%, even if the contents of other elements are within the range of the present embodiment, the strength of the steel material will become excessively high and the workability of the steel material will decrease. Therefore, the content of B is to be 0 to 0.0050%, and when B is contained, the content of B is to be within the range of more than 0 to 0.0050%. A preferable lower limit of the content of B is 0.0001%, more preferably is 0.0005%, further preferably is 0.0010%, further preferably is 0.0015%, and further preferably is 0.0020%. A preferable upper limit of the content of B is 0.0049%, more preferably is 0.0048%, further preferably is 0.0047%, further preferably is 0.0045%, further preferably is 0.0043%, and further preferably is 0.0040%.

[Regarding Impurity Elements]

Note that, the chemical composition of the steel material according to the present embodiment may further contain, as an impurity, one or more kinds selected from the group consisting of Cu, Al and Ti in lieu of a part of Fe. If the contents of these elements are within the ranges described hereunder, the aforementioned advantageous effects of the steel material according to the present embodiment will be sufficiently obtained.

Cu: 0 to 0.050%

Copper (Cu) is an impurity, and preferably is not contained. That is, the content of Cu may be 0%. If the content of Cu is more than 0.050%, even if the contents of other elements are within the range of the present embodiment, the workability of the steel material will markedly decrease. Therefore, the content of Cu is to be 0 to 0.050%. A preferable upper limit of the content of Cu is 0.045%, more preferably is 0.040%, further preferably is 0.038%, and further preferably is 0.036%. As mentioned above, the content of Cu is preferably as low as possible. However, excessively reducing the content of Cu will raise the production cost. Therefore, a preferable lower limit of the content of Cu is more than 0%, more preferably is 0.001%, and further preferably is 0.002%.

Al: 0 to 0.0050%

Aluminum (Al) is an impurity, and preferably is not contained. That is, the content of Al may be 0%. Al forms coarse non-metallic inclusions, and thereby decreases the fatigue strength of a spring produced using the steel material. If the content of Al is more than 0.0050%, even if the contents of other elements are within the range of the present embodiment, the fatigue strength of the spring will markedly decrease. Therefore, the content of Al is to be 0 to 0.0050%. A preferable upper limit of the content of Al is 0.0045%, more preferably is 0.0040%, further preferably is 0.0035%, further preferably is 0.0032%, and further preferably is 0.0030%. As mentioned above, the content of Al is preferably as low as possible. However, excessively reducing the content of Al will raise the production cost. Therefore, a preferable lower limit of the content of Al is more than 0%, more preferably is 0.0001%, and further preferably is 0.0005%.

Ti: 0 to 0.050%

Titanium (Ti) is an impurity, and preferably is not contained. That is, the content of Ti may be 0%. Ti forms coarse TiN. TiN easily becomes a starting point of a fracture. Therefore, TiN decreases the fatigue strength of a spring produced using the steel material. If the content of Ti is more than 0.050%, even if the contents of other elements are within the range of the present embodiment, the fatigue strength of the spring will markedly decrease. Therefore, the content of Ti is to be 0 to 0.050%. A preferable upper limit of the content of Ti is 0.045%, more preferably is 0.040%, further preferably is 0.035%, further preferably is 0.032%, and further preferably is 0.030%. As mentioned above, the content of Ti is preferably as low as possible. However, excessively reducing the content of Ti will raise the production cost. Therefore, a preferable lower limit of the content of Ti is more than 0%, more preferably is 0.001%, further preferably is 0.003%, and further preferably is 0.005%.

[Microstructure of Steel Material]

The microstructure of the steel material of the present embodiment is a structure mainly composed of pearlite. Here, the phrase “the microstructure is a structure mainly composed of pearlite” means that the area fraction of pearlite in the microstructure is 90% or more. Note that, phases other than pearlite are, for example, precipitates, inclusions, ferrite, and a hard phase (martensite and/or bainite). Note that, the area fractions of precipitates and inclusions are negligibly small compared to the other phases.

[Method for Measuring Area Fraction of Pearlite]

The area fraction of pearlite can be determined by the following method.

A cross section (surface) obtained by cutting the steel material in a direction perpendicular to the longitudinal direction of the steel material, that is, in a wire diameter direction of the steel material is adopted as an observation surface. The observation surface is minor-polished. The minor-polished observation surface is subjected to etching with 5% picric acid alcohol (picral etching reagent). On the etched observation surface, a position at a depth that is ¼ of the diameter in a radial direction from the steel material surface (outer circumference of the observation surface) is defined as an observation visual field. Observation visual fields at 10 locations are observed using a scanning electron microscope (SEM) at a magnification of ×2000, and photographic images of the 10 observation visual fields are generated. The size of each visual field is set to 40 μm×60 μm.

In each observation visual field, with respect to the respective phases such as pearlite, ferrite, a hard phase, precipitates, and inclusions, the contrast and phase morphology differ for each phase. Therefore, pearlite is identified based on contrast and morphology. Pearlite has a lamellar morphology composed of alternating layers of cementite and ferrite. Therefore, one skilled in the art can readily distinguish pearlite from other phases based on the contrast and morphology. The gross area (μm²) of pearlite in each observation visual field is determined. The proportion of the gross area of pearlite in all of the observation visual fields relative to the gross area (24000 μm²) of all the observation visual fields is defined as the area fraction (%) of pearlite. The area fraction of pearlite is taken as a value (that is, an integer) obtained by rounding off the value of the first decimal place.

The area fraction of pearlite in the microstructure of the steel material of the present embodiment is 90% or more. Therefore, in comparison to a steel material mainly composed of a hard phase (martensite and/or bainite), it is easy to grind the steel material surface in a shaving treatment, and the cold workability is also high. As described above, in a process for producing a spring, a steel material is subjected to a shaving treatment, and is also subjected to wire drawing. Therefore, the steel material of the present embodiment is suitable for producing springs. Note that, in the steel material of the present embodiment, a preferable lower limit of the area fraction of pearlite is 91%, and further preferably is 92%.

[Volumetric Number Density of V-Based Precipitates]

In the steel material of the present embodiment, in the ferrite in the pearlite, the volumetric number density of V-based precipitates having a maximum diameter of 2 to 20 nm is 3000 to 80000 pieces/μm³. In the present description, the term “volumetric number density of V-based precipitates” means the number of V-based precipitates per unit volume (1 μm³ in the present specification).

In the present description, the term “V-based precipitates” refers to precipitates that contain V. The V-based precipitates may also contain Cr along with V. The V-based precipitates are for example, V carbides and V carbo-nitrides. The V-based precipitates may be composite precipitates containing a V carbide and another element other than V, Cr, and C, or may be composite precipitates containing a V carbo-nitride and another element other than V, Cr, C and N. The V-based precipitates are extremely fine compared to Fe carbides such as cementite. Therefore, the V-based precipitates can be easily distinguished from Fe carbides such as cementite, and thus the V-based precipitates can be identified. Note that, as will be described later, with regard to V-based precipitates, V, or V and Cr are detected by elemental analysis using an energy-dispersive X-ray spectroscopy (EDS), and according to analysis using nano-beam electron diffraction (NBD), the crystal structure is cubic and the lattice constants a, b, and c are each 0.4167 nm±5% (in conformity with ICDD (International Center for Diffraction Data) No. 065-8822).

In the steel material of the present embodiment, a large number of fine V-based precipitates having a maximum diameter of 2 to 20 nm are caused to precipitate in the ferrite in the pearlite. In a case where a shaving treatment is performed on the steel material of the present embodiment, these fine V-based precipitates make it easy to break apart ferrite in chips that are generated from the steel material surface by the shaving treatment. Therefore, it becomes easy to break the chips into short pieces. As a result, the occurrence of a situation in which a part of a chip remains on the steel material surface, or a steel material portion near the root of a chip is gouged, or a crack occurs in the steel material surface near the root of a chip can be suppressed. That is, the occurrence of shaving-induced surface defects is suppressed, and surface deterioration of the steel material surface is suppressed.

In the ferrite in the pearlite, when the volumetric number density of V-based precipitates having a maximum diameter of 2 to 20 nm is less than 3000 pieces/μm³, the volumetric number density of V-based precipitates is insufficient. In this case, surface deterioration of the steel material surface after a shaving treatment cannot be sufficiently suppressed. In the ferrite in the pearlite, when the volumetric number density of V-based precipitates having a maximum diameter of 2 to 20 nm is 3000 pieces/μm 3 or more, the volumetric number density of V-based precipitates in the ferrite in the pearlite is sufficiently high. Therefore, in a process for producing a spring using the steel material as a starting material, in a case where the steel material is subjected to a shaving treatment, surface deterioration of the steel material surface after the shaving treatment can be sufficiently suppressed, and the smoothness of the steel material surface can be increased. Therefore, in the steel material of the present embodiment, on the precondition that the content of each element in the chemical composition is within the range of the present embodiment, the volumetric number density of V-based precipitates having a maximum diameter of 2 to 20 nm in ferrite in the pearlite is 3000 pieces/μm 3 or more. A preferable lower limit of the volumetric number density of V-based precipitates having a maximum diameter of 2 to 20 nm in ferrite in the pearlite is 3500 pieces/μm³, more preferably is 4000 pieces/μm³, further preferably is 4500 pieces/μm³, further preferably is 5000 pieces/μm³, further preferably is 5500 pieces/μm³, further preferably is 6000 pieces/μm³, further preferably is 6500 pieces/μm³, further preferably is 7000 pieces/μm³, further preferably is 8000 pieces/μm³, further preferably is 9000 pieces/μm³, further preferably is 10000 pieces/μm³, and further preferably is 15000 pieces/μm³.

Note that, an upper limit of the volumetric number density of V-based precipitates having a maximum diameter of 2 to 20 nm is not particularly limited. However, when the content of each element in the chemical composition of the steel material is within the range of the present embodiment, an upper limit of the volumetric number density of V-based precipitates having a maximum diameter of 2 to 20 nm in ferrite in the pearlite is 80000 pieces/μm³. A preferable upper limit of the volumetric number density of V-based precipitates having a maximum diameter of 2 to 20 nm in ferrite in the pearlite is 75000 pieces/μm³, and more preferably is 72000 pieces/μm³.

[Method for Measuring Volumetric Number Density of V-Based Precipitates]

The volumetric number density (pieces/μm³) of V-based precipitates having a maximum diameter of 2 to 20 nm in ferrite in the pearlite can be determined by the following method. The steel material (wire rod) according to the present embodiment is cut in the wire diameter direction. A disk having a cross section in the wire diameter direction and a thickness of 0.5 mm in the central axis direction of the steel material is extracted. Grinding and polishing are performed from both sides of the disk using emery paper to make the thickness of the disk 60 μm. Thereafter, a sample with a diameter of 3 mm is taken from the disc. The sample is immersed in 10% perchloric acid-glacial acetic acid solution to perform electropolishing and thereby prepare a thin foil sample having a thickness of 100 nm.

The prepared thin foil sample is observed using a transmission electron microscope (TEM). Specifically, five locations (observation visual fields) on a surface (observation surface) in the wire diameter direction of the thin foil sample are observed at an observation magnification of ×200000 and an acceleration voltage of 200 kV. At such time, observation visual fields within ferrite in the pearlite are selected. The size of each observation visual field is set to 0.09 μm×0.09 μm.

As described above, pearlite can be easily distinguished from other phases by contrast and morphology. Specifically, in the TEM observation, pearlite can be identified as a lamellar structure that is a striped pattern of white regions and black regions. Here, in the lamellar structure, the white regions are ferrite and the black regions are cementite. Therefore, identification of ferrite in the pearlite can be easily performed by distinguishing the ferrite in the pearlite from the cementite in the pearlite based on contrast. Accordingly, observation visual fields are selected at five locations in the ferrite in the pearlite based on the contrast.

In addition, in each observation visual field, precipitates can be identified based on contrast. Therefore, precipitates which have a maximum diameter of 2 to 20 nm are identified from among a plurality of precipitates that are identified. Here, the term “maximum diameter” means a maximum line segment length in a case where an arbitrary two points at an interface between a precipitate and the parent phase are selected, and all of a line segment connecting the two points is included in the relevant precipitate.

In the observation visual fields, precipitates that have a maximum diameter of 2 to 20 nm are V-based precipitates. Therefore, the precipitates that have a maximum diameter of 2 to 20 nm are recognized as being V-based precipitates. Note that, the fact that the precipitates that have a maximum diameter of 2 to 20 nm are V-based precipitates can be confirmed using EDS and NBD. Specifically, elemental analysis is conducted with respect to the precipitates by irradiating a beam at each precipitate having a maximum diameter of 2 to 20 nm and detecting characteristic X-rays. In addition, for each precipitate having a maximum diameter of 2 to 20 nm, a nano-beam electron diffraction (NBD) is obtained by nano beam diffraction (nano beam electron diffraction). The obtained nano-beam electron diffraction is analyzed to determine the crystal structure and lattice constants of the relevant precipitate. If V, or V and Cr are detected by the EDS, and in addition, the result of analyzing the NBD indicates that the crystal structure is cubic and the lattice constants a, b, and c are each 0.4167 nm±5%, the relevant precipitate is a V-based precipitate.

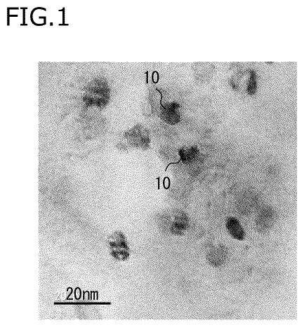

FIG. 1 is one example of a TEM image of ferrite in pearlite of a thin foil sample. In the TEM image in FIG. 1, reference numeral 10 denotes a V-based precipitate.

The total number of V-based precipitates having a maximum diameter of 2 to 20 nm in the five observation visual fields is determined by the above method. The volumetric number density (pieces/μm³) of the V-based precipitates having a maximum diameter of 2 to 20 nm is then determined based on the determined total number of V-based precipitates and the total volume of the five observation visual fields.

As described above, in the steel material of the present embodiment, the content of each element in the chemical composition is within the range of the present embodiment, and the area fraction of pearlite in the microstructure is 90% or more. In addition, in the ferrite in the pearlite, the volumetric number density of V-based precipitates having a maximum diameter of 2 to 20 nm is 3000 to 80000 pieces/μm³. Therefore, in the shaving treatment during a process for producing a spring, the steel material of the present embodiment can sufficiently suppress the occurrence of shaving-induced surface defects such as burrs, gouges, and cracks on the steel material surface after the shaving treatment. As a result, surface deterioration of the steel material surface after the shaving treatment can be sufficiently suppressed, and the smoothness of the steel material surface can be sufficiently increased.

[Method for Producing Steel Material of Present Embodiment]

Hereunder, one example of a method for producing the steel material of present embodiment is described. Note that, as long as the steel material of the present embodiment is composed as described above, the production method is not limited to the production method described hereinafter. However, the production method described hereunder is one favorable example for producing the steel material of the present embodiment.

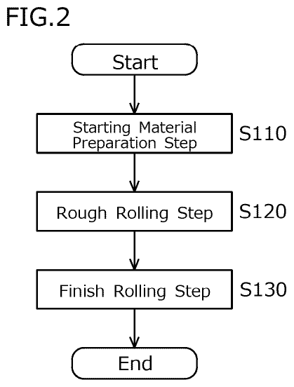

FIG. 2 is a flowchart illustrating one example of a process for producing the steel material of the present embodiment. Referring to FIG. 2, the method for producing the steel material of the present embodiment includes a starting material preparation step (S110), a roughing step (S120), and a finish rolling step (S130). Each step is described in detail hereunder.

[Starting Material Preparation Step (S110)]

In the starting material preparation step (S110), a starting material having the chemical composition described above is produced. The term “starting material” used here refers to a bloom or an ingot. In the starting material preparation step (S110), first, a molten steel in which the content of each element in the chemical composition is within the range of the present embodiment is produced by a well-known refining method. The produced molten steel is used to produce a starting material (a bloom or an ingot). Specifically, a bloom is produced by a continuous casting process using the molten steel. Alternatively, an ingot is produced by an ingot-making process using the molten steel.

[Roughing Step (S120)]

In the roughing step (S120), the starting material is subjected to hot rolling to produce a billet. Specifically, in the roughing step (S120), first, the starting material is heated. A heating furnace or a soaking pit is used for heating the starting material. The starting material is heated to within a range of 1200 to 1300° C. by the heating furnace or soaking pit. For example, the starting material is held for 1.5 to 50.0 hours at a furnace temperature of 1200 to 1300° C. After heating, the starting material is extracted from the heating furnace or soaking pit and subjected to hot rolling. For example, a blooming mill is used for the hot rolling in the roughing step (S120). The blooming mill is used to subject the starting material to blooming to produce a billet. If a continuous mill is arranged downstream of the blooming mill, the continuous mill may be used to further perform hot rolling on the billet obtained after the blooming, to thereby produce a billet of an even smaller size. In the continuous mill, roll stands (horizontal stands) having a pair of horizontal rolls, and roll stands (vertical stands) having a pair of vertical rolls are alternately arranged in a row. By the above process, the starting material (bloom or ingot) is produced into a billet in the roughing step (S120).

[Finish Rolling Step (S130)]

In the finish rolling step (S130), the billet is subjected to hot rolling to produce the steel material (wire rod). In the finish rolling step (S130), first, a heating furnace is used to heat the billet after the roughing step (S120).

[Regarding Heating in Finish Rolling Step]

The heating temperature in the heating furnace in the finish rolling step is set to 1050° C. or more. The holding time at the heating temperature of 1050° C. or more is set to, for example, 0.5 to 5.0 hours.

With regard to the billet produced in the roughing step (S120), in some cases V-based precipitates form in the billet due to cooling after the hot rolling. If a billet is subjected to finish rolling in a state in which V-based precipitates remain in the billet, coarse V-based precipitates will excessively form in ferrite in the pearlite of the steel material after the finish rolling step. As a result, the volumetric number density of V-based precipitates having a maximum diameter of 2 to 20 nm will be less than 3000 pieces/μm³ in the ferrite in the pearlite.

If the heating temperature in the finish rolling step (S130) is 1050° C. or more, V-based precipitates that have a possibility of remaining in the billet after the roughing step (S120) can be sufficiently dissolved. Therefore, on the precondition that the other production conditions are satisfied, formation of coarse V-based precipitates having a maximum diameter of more than 20 nm is suppressed, and the volumetric number density of V-based precipitates having a maximum diameter of 2 to 20 nm is 3000 pieces/μm³ or more in the ferrite in the pearlite of the steel material after the finish rolling step.

[Regarding Finish Rolling]

The heated billet is subjected to hot rolling (finish rolling) using a finish rolling mill train to produce a wire rod as the steel material. Although the outer diameter of the wire rod is not particularly limited, for example, the outer diameter of the wire rod is 5 to 10 mm. The outer diameter of the steel material (wire rod) is determined based on the wire diameter of the spring that is the end product. The finish rolling mill train, and hot rolling using the finish rolling mill train are described in detail hereunder.

[Regarding Finish Rolling Mill Train]

The finish rolling mill train includes a plurality of roll stands arranged in a row in the direction from upstream towards downstream. Each stand includes a plurality of rolls arranged around a pass line. A groove is formed in the rolls of the respective stands. The billet is passed through the groove formed by a plurality of rolls of each stand for subjecting the billet to hot rolling to reduce the cross section of the billet in a stepped manner and produce the steel material (wire rod).

Among the plurality of roll stands of the finish rolling mill train, a group of a plurality of roll stands which are arranged consecutively from the most upstream roll stand is called a “roughing train”. A group of a plurality of roll stands which are arranged downstream of the roughing train and which are arranged consecutively is called an “intermediate train”. One roll stand or a group of a plurality of roll stands arranged consecutively downstream of the intermediate train is called a “finishing train”. In short, for convenience, the finish rolling mill train is divided into three roll stand groups in the direction from upstream towards downstream, namely, the roughing train, the intermediate train, and the finishing train. The number of roll stands of the roughing train, the number of roll stands of the intermediate train, and the number of roll stands of the finishing train are not particularly limited. In order to describe the thermal history of the steel material during finish rolling which will be described later, for convenience, the finish rolling mill train is divided into three roll stand groups (roughing train, intermediate train, and finishing train). Note that, quenching equipments for cooling the steel material are arranged between several roll stands of the roughing train, the intermediate train, and the finishing train. The quenching equipment, for example, performs water cooling on the steel material that exits the preceding roll stand and enters a subsequent roll stand which is the next roll stand, that is, performs water cooling on a steel material portion between the preceding roll stand and the subsequent roll stand, and thus lowers the steel material temperature.

[Regarding Thermal History of Steel Material During Finish Rolling]

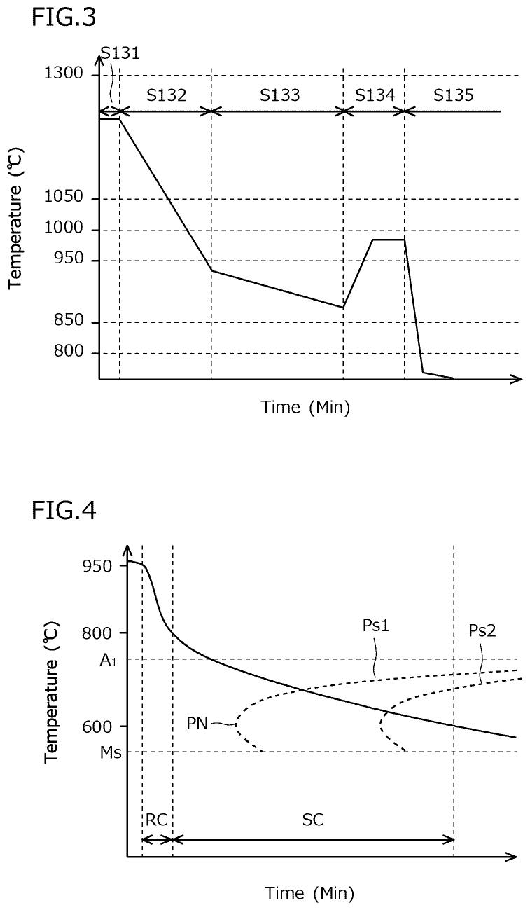

FIG. 3 is a schematic diagram illustrating the thermal history of the steel material during finish rolling. Referring to FIG. 3, a section S131 is the thermal history of the steel material during a period until the steel material extracted from the heating furnace reaches the first roll stand of the roughing train of the finish rolling mill train. A section S132 is the thermal history of the steel material while in the roughing train. A section S133 is the thermal history of the steel material while in the intermediate train. A section S134 is the thermal history of the steel material while in the finishing train. A section S135 is the thermal history of the steel material after exiting from the last roll stand of the finishing train. In the finish rolling step, the thermal history of the steel material of the present embodiment undergoes the changes as illustrated in sections S131 to S135 shown in FIG. 3 to produce the steel material. The respective sections S131 to S135 are described hereunder.

First, the thermal history of a common steel material in a case of producing a steel material (wire rod) in a finish rolling step will be described. In the period from when the steel material is extracted from the heating furnace until the steel material reaches the first roll stand of the roughing train, the steel material temperature is maintained at the heating temperature of the heating furnace. Then, when hot rolling is started at the roughing train, heat of the steel material is taken by the rolls of the roll stand. This phenomenon is referred to as “roll heat dissipation”. During rolling at the roughing train, the temperature of the steel material decreases with the passage of time due to roll heat dissipation. However, the steel material is subjected to rolling reduction in stepped manner by the plurality of roll stands, and when the accumulative rolling ratio of the steel material increases to a certain level, processing-incurred heat is generated in the steel material. In the steel material in which the processing-incurred heat is generated, the steel material temperature rises. Therefore, in the conventional finish rolling, the steel material temperature rises again during rolling at subsequent rolling stands of the roughing train, or during rolling at the intermediate train. The steel material temperature also continues to rise at the finishing train.

Therefore, in the present embodiment, in order to make the volumetric number density of V-based precipitates having a maximum diameter of 2 to 20 nm in ferrite in the pearlite of the steel material after the finish rolling step fall within a suitable range, the thermal history of the steel material during finish rolling is adjusted as follows.

In the finish rolling step (S130) of the present embodiment, a time period for which the surface temperature of the billet is continuously within the range of 950 to 850° C. (referred to as “specific temperature residence time”) during finish rolling is made 5 to 100 seconds. The specific temperature residence time influences the volumetric number density of V-based precipitates having a maximum diameter of 2 to 20 nm in ferrite in the pearlite of the steel material after the finish rolling step (S130). Specifically, if the specific temperature residence time during finish rolling is made 5 to 100 seconds, on the precondition that the other production conditions are satisfied, the volumetric number density of V-based precipitates having a maximum diameter of 2 to 20 nm in ferrite in the pearlite of the steel material after the finish rolling step will be 3000 to 80000 pieces/μm³.

Although the reason why, on the precondition that the other production conditions are satisfied, the volumetric number density of V-based precipitates having a maximum diameter of 2 to 20 nm in ferrite in the pearlite of the steel material after the finish rolling step will be 3000 to 80000 pieces/μm³ if the specific temperature residence time is made 5 to 100 seconds is not definite, the following reason is conceivable. If the specific temperature residence time is 5 to 100 seconds, on the precondition that the other production conditions are satisfied, clusters of V atoms or of V atoms and Cr atoms are formed in the billet during finish rolling. Here, the phrase “clusters of V atoms or of V atoms and Cr atoms” (hereinafter, also referred to as simply “clusters”) means sets of atoms formed at a stage that precedes the formation of V-based precipitates. If a large number of clusters are formed before V-based precipitates are formed, interphase boundary precipitation of V-based precipitates will be promoted in a cooling treatment (described later) after finish rolling. As a result, in the ferrite in the pearlite of the steel material, the V-based precipitates having a maximum diameter of 2 to 20 nm will be 3000 to 80000 pieces/μm³.

The temperature range (950 to 850° C.) of the specific temperature residence time mentioned above is directly below the solutionizing temperature range (approximately 1000 to 1150° C.) of V-based precipitates. Therefore, in the temperature range (950 to 850° C.) of the specific temperature residence time, in comparison to the solutionizing temperature range, a driving force for forming nuclei of V-based precipitates is small, and it is difficult for the formation of nuclei of V-based precipitates to occur. On the other hand, V atoms and/or Cr atoms that are dissolved in the billet are sufficiently diffused in the billet. As a result, clusters that serve as a preliminary stage to nucleation of V-based precipitates are formed. By ensuring a specific temperature residence time of 5 to 100 seconds, a large number of clusters can be formed. As a result, the volumetric number density of V-based precipitates having a maximum diameter of 2 to 20 nm is 3000 to 80000 pieces/μm³ in the ferrite in the pearlite of the steel material after the cooling treatment of the finish rolling step (S130).

The mechanism described above is an assumption. However, even if a different mechanism is acting, the fact that if the specific temperature residence time is 5 to 100 seconds, the volumetric number density of V-based precipitates having a maximum diameter of 2 to 20 nm is 3000 to 80000 pieces/μm³ in the ferrite in the pearlite of the steel material after the cooling treatment of the finish rolling step (S130) is demonstrated by Examples which are described later.

If the specific temperature residence time is less than five seconds, the formation of clusters will be insufficient. As a result, the volumetric number density of V-based precipitates having a maximum diameter of 2 to 20 nm will be less than 3000 pieces/μm³ in the ferrite in the pearlite of the steel material after the cooling treatment of the finish rolling step (S130). On the other hand, if the specific temperature residence time is more than 100 seconds, precipitates will form from the clusters. Consequently, the V-based precipitates after the finish rolling step will be coarse, and V-based precipitates having a maximum diameter of more than 20 nm will form in a large amount. As a result, the volumetric number density of V-based precipitates having a maximum diameter of 2 to 20 nm will be less than 3000 pieces/μm³ in the ferrite in the pearlite of the steel material after the finish rolling step (S130). Therefore, the specific temperature residence time is to be 5 to 100 seconds.

A preferable lower limit of the specific temperature residence time is 8 seconds, more preferably is 10 seconds, and further preferably is 12 seconds. A preferable upper limit of the specific temperature residence time is 90 seconds, more preferably is 80 seconds, further preferably is 70 seconds, and further preferably is 60 seconds.

Referring to FIG. 3, in the rolling period (S132) at the roughing train, a heat dissipation amount (roll heat dissipation) due to contact between the surface of rolls and the surface of the billet is greater than a processing-incurred heat amount that accompanies rolling by the rolls. Therefore, in the rolling period (S132) at the roughing train, the surface temperature of the billet decreases each time the billet passes through a roll stand.

On the other hand, in the rolling period (S133) at the intermediate train, the processing-incurred heat amount is liable to become greater than the amount of roll heat dissipation. Therefore, in the rolling period (S133) at the intermediate train, the surface temperature of the billet is liable to increase each time the billet passes through a roll stand. Therefore, in order to secure the specific temperature residence time of 5 to 100 seconds, the billet is water-cooled during the rolling period at the intermediate train to thereby lower the billet surface temperature. Specifically, the portion of the billet which is passing between the roll stands is water-cooled by a quenching equipment arranged between the roll stands of the intermediate train. By this means, the surface temperature of the billet during finish rolling is adjusted so that the specific temperature residence time during finish rolling is 5 to 100° C.

Note that, in the above description the specific temperature residence time of 5 to 100 seconds is secured by water-cooling the billet during the rolling period at the intermediate train. However, a method for adjusting the specific temperature residence time during finish rolling is not limited to the method described above. The surface temperature of the billet during the rolling period (S132) at the roughing train may be adjusted by water-cooling or the like, or the surface temperature of the billet during the rolling period (S134) at the finishing train may be adjusted by water-cooling or the like. Further, the surface temperature of the billet may be adjusted by water-cooling or the like in two or more sections among the rolling period at the roughing train (S132), the rolling period at the intermediate train (S133), and the rolling period at the finishing train (S134).

Note that, the residence time when the surface temperature of the billet is 950 to 850° C. (specific temperature residence time) means, as described above, a time period in which a state in which the surface temperature of the billet is continuously 950 to 850° C. continues.

[Regarding Rolling Finishing Temperature]

In the rolling period (S134) at the finishing train, the surface temperature of the billet is liable to increase due to processing-incurred heat. Here, the surface temperature of the steel material on the exit side of the roll stand where rolling reduction was last performed at the finishing train is defined as the “rolling finishing temperature” (° C.). In the present embodiment, the rolling finishing temperature is to be less than 1000° C. If the rolling finishing temperature is 1000° C. or more, austenite grains in the steel material will coarsen. In this case, as will be also described in relation to the cooling treatment which is described later, fine V-based precipitates having a maximum diameter of less than 2 nm will be formed in a large amount. As a result, in the ferrite in the pearlite of the steel material after the finish rolling step (S130), the volumetric number density of V-based precipitates having a maximum diameter of 2 to 20 nm will be less than 3000 pieces/μm³.

For example, as illustrated in FIG. 3, the rolling finishing temperature in the rolling period (S134) at the finishing train may be controlled to less than 1000° C. by, in the rolling periods (S132 and S133) at the roughing train and the intermediate train, making the specific temperature residence time 5 to 100 seconds and making the billet temperature on the exit side of the last roll stand of the intermediate train 950° C. or less. Further, a configuration may also be adopted in which the billet surface is cooled during the rolling period (S134) at the finishing train to make the rolling finishing temperature less than 1000° C. Note that, a preferable lower limit of the rolling finishing temperature is 900° C.

Note that, as illustrated in FIG. 3, during finish rolling, the steel material temperature (surface temperature of the steel material) is maintained at less than 1000° C. from after the specific temperature residence time passes until rolling at the finishing train is completed.

In FIG. 3, the entire rolling period at the intermediate train is included in the specific temperature residence time. However, the specific temperature residence time is not limited thereto. One portion of the rolling period at the intermediate train may correspond to the specific temperature residence time. Further, the specific temperature residence time is not limited to the rolling period at the intermediate train. In short, it suffices that, during finish rolling, a period (specific temperature residence time) in which the steel material temperature is continuously within the range of 950° C. to 850° C. is 5 to 100 seconds, and the rolling finishing temperature is less than 1000° C.

Note that, the thermal history of the steel material during finish rolling can be measured, for example, by the following method. A thermometer capable of measuring the surface temperature of the steel material is arranged on the entrance side or exit side of each stand of the finish rolling mill train (roughing train, intermediate train, and finishing train). The thermal history of the steel material during finish rolling can be determined based on measurement results obtained by these thermometers.

[Cooling Treatment (Section S135)]

A cooling treatment is performed on the steel material immediately after completing finish rolling at the finish rolling mill train (roughing train, intermediate train, and finishing train) (S135). In the cooling treatment section (S135), a rapid cooling treatment RC is performed, and next a slow cooling treatment SC is performed. By performing the cooling treatment, the volumetric number density of V-based precipitates having a maximum diameter of 2 to 20 nm is made 3000 to 80000 pieces/μm³ in the ferrite in the pearlite of the steel material after the finish rolling step (S130). Hereunder, the rapid cooling treatment RC and the slow cooling treatment SC are described.

[Rapid Cooling Treatment (RC)]

In the rapid cooling step (RC), the steel material after completion of finish rolling which is the steel material whose surface temperature is in the temperature range of 950 to 800° C. is subjected to rapid cooling. Specifically, the billet after completion of finish rolling is subjected to cooling in which the average cooling rate of the surface temperature thereof is to be more than 1.0° C./sec in the range from 950 to 800° C. If the average cooling rate when the surface temperature of the steel material is 950 to 800° C. is 1.0° C./sec or less, even if the other production conditions are satisfied, austenite grains in the steel material will coarsen. In this case, a large amount of V-based precipitates having a maximum diameter of less than 2 nm will form. As a result, in the ferrite in the pearlite of the steel material after the finish rolling step (S130), the volumetric number density of V-based precipitates having a maximum diameter of 2 to 20 nm will be less than 3000 pieces/μm³.

If the average cooling rate when the surface temperature of the steel material is 950 to 800° C. is more than 1.0° C./sec, on the precondition that the other production conditions are satisfied, in the ferrite in the pearlite of the steel material after the finish rolling step (S130), the volumetric number density of V-based precipitates having a maximum diameter of 2 to 20 nm will be 3000 to 80000 pieces/μm³.

Although the reason why V-based precipitates can be prevented from becoming excessively fine in pearlite if coarsening of austenite grains in the steel material is suppressed is not definite, the following reason is conceivable.

FIG. 4 is a graph illustrating a continuous cooling transformation curve (CCT curve) during the period (S135) of the cooling treatment of the steel material of the present embodiment. Referring to FIG. 4, a solid-line curve in the graph in FIG. 4 represents temperature changes of the steel material with respect to the cooling time. In FIG. 4, broken-line curves Ps (curves Ps1 and Ps2) represent the pearlite transformation start temperature. If austenite grains in the steel material are fine, the curve Ps shifts to the short time period side (the left side in the drawing) (corresponds to the curve Ps1 in FIG. 4). If the curve Ps shifts to the short time period side, in the slow cooling treatment (SC) after the rapid cooling treatment (RC), pearlite transformation is started on a high temperature side relative to a pearlite nose PN. If pearlite transformation is started, V-based precipitates precipitate at interphase boundaries in ferrite in the pearlite. V-based precipitates are formed on the high temperature side relative to the pearlite nose PN. Therefore, the formed V precipitates grow to a certain extent. As a result, the volumetric number density of V-based precipitates having a maximum diameter of 2 to 20 nm in ferrite in the pearlite can be made 3000 to 80000 pieces/μm³.

On the other hand, in a case where austenite grains in the steel material are coarse, the curve Ps shifts to the long time period side (the right side in the drawing) (corresponds to the curve Ps2 in FIG. 4). In this case, pearlite transformation is started in a lower temperature region in comparison to the case of the curve Ps1. Therefore, although V-based precipitates are formed, it is difficult for the V-based precipitates to grow. Consequently, V-based precipitates having a maximum diameter of less than 2 nm are formed in a large amount, and as a result the volumetric number density of V-based precipitates having a maximum diameter of 2 to 20 nm in ferrite in the pearlite is less than 3000 pieces/μm³.

[Slow cooling treatment (SC)] The slow cooling treatment (SC) is performed promptly after the rapid cooling treatment (RC). In the slow cooling treatment (SC), the steel material is cooled in a manner so that the average cooling rate when the surface temperature of the steel material is in the range of less than 800° C. to 600° C. is less than 2.00° C./sec. If the average cooling rate when the surface temperature of the steel material is in the range of less than 800° C. to 600° C. is 2.00° C./sec or more, even if the other production conditions are satisfied, pearlite transformation will be insufficient. As a result, the area fraction of pearlite will be less than 90%. In addition, because the pearlite transformation is insufficient, the interphase boundary precipitation of V-based precipitates will also be insufficient. Consequently, the volumetric number density of V-based precipitates having a maximum diameter of 2 to 20 nm in ferrite in the pearlite will be less than 3000 pieces/μm³.

In the slow cooling treatment (SC), if the average cooling rate when the surface temperature of the steel material is in the range of less than 800° C. to 600° C. is less than 2.00° C./sec, pearlite transformation will be sufficiently promoted. As a result, the area fraction of pearlite will be 90% or more. In addition, because interphase boundary precipitation of V-based precipitates will also be sufficiently promoted, the volumetric number density of V-based precipitates having a maximum diameter of 2 to 20 nm in ferrite in the pearlite will be 3000 to 80000 pieces/μm³.

The steel material (wire rod) of the present embodiment can be produced by the above production process. Note that, the production method described above is one example for producing the steel material of the present embodiment. Accordingly, as long as a steel material can be produced in which the content of each element in the chemical composition of the steel material is within the range of the present embodiment, the area fraction of pearlite in the microstructure is 90% or more, and the volumetric number density of V-based precipitates having a maximum diameter of 2 to 20 nm in the ferrite in the pearlite is 3000 to 80000 pieces/μm³, a method for producing the steel material of the present embodiment is not limited to the production method described above.

[Regarding Spring]

A spring for which the steel material of the present embodiment is used as a starting material is, for example, a spring to be used in automobiles and general machinery. A spring used in automobiles and general machinery is, for example, a damper spring or a valve spring.

[Method for Producing Spring that Uses Steel Material of Present Embodiment as Starting Material]

A spring for which the steel material of the present embodiment is used as a starting material is produced by a well-known production method. For example, a spring for which the steel material of the present embodiment is used as a starting material is produced by the following method.

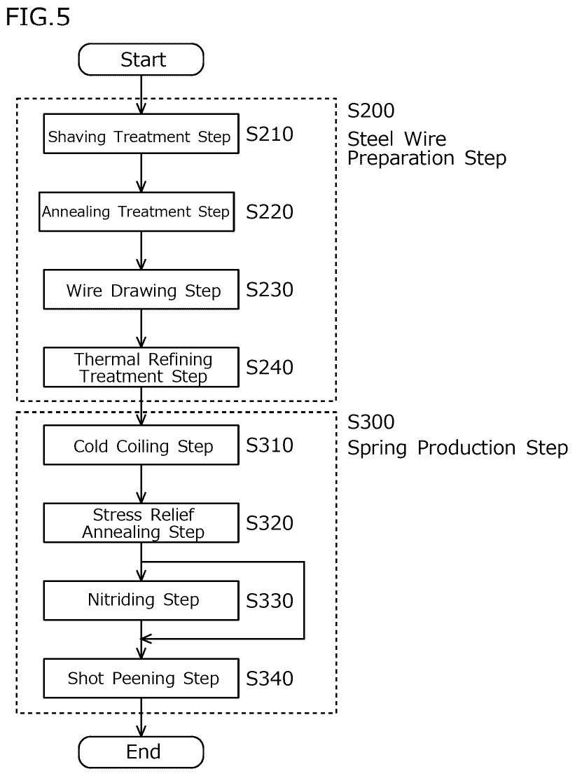

FIG. 5 is a flowchart illustrating one example of a method for producing a spring using the steel material of the present embodiment. Referring to FIG. 5, a method for producing a spring that uses the steel material of the present embodiment as a starting material includes a steel wire preparation step (S200) and a spring production step (S300).

In the steel wire preparation step (S200), a steel wire for a spring is produced using the steel material of the present embodiment. Here, the term “steel wire” means a steel material obtained by subjecting a steel material (wire rod) that is a hot rolling material to wire drawing one or more times. The steel wire preparation step (S200) includes a shaving treatment step (S210), an annealing treatment step (S220), a wire drawing step (S230), and a quenching and tempering step (S240).

[Shaving Treatment Step (S210)]

In the shaving treatment step (S210), the entire surface (peripheral surface) of the steel material is peeled (subjected to a shaving treatment). It suffices that the shaving treatment is performed by a well-known method. In the shaving treatment, the steel material (wire rod) is passed through a shaving die to shave off (peel off) the steel material surface. Surface defects or a decarburizing layer on the surface of the steel material are removed by the shaving treatment.

As described above, when the steel material of the present embodiment is subjected to the shaving treatment, chips generated on the steel material surface by the shaving treatment are easily broken into short pieces. Therefore, the occurrence of shaving-induced surface defects such as burrs, gouges, and cracks on the steel material surface after the shaving treatment can be sufficiently suppressed. As a result, surface deterioration of the steel material surface after the shaving treatment can be sufficiently suppressed, and the smoothness of the steel material surface can be sufficiently increased.

[Annealing Treatment Step (S220)]

In the annealing treatment step (S220), the steel material after the shaving treatment step (S210) is subjected to an annealing treatment to remove strain in the steel material generated by the shaving treatment. It suffices to perform the annealing treatment by a well-known method. The temperature in the annealing treatment is, for example, 300° C. or more.

[Wire Drawing Step (S230)]

In the wire drawing step (S230), the steel material after the annealing treatment step (S220) is subjected to wire drawing. By performing wire drawing, a steel wire having a desired outer diameter is produced. It suffices to perform the wire drawing step (S230) by a well-known method. Specifically, the steel material is subjected to a lubrication treatment, and a lubricant coating as typified by a phosphate coating film or a metallic soap layer is formed on the surface of the steel material. The steel material after the lubrication treatment is subjected to wire drawing at normal temperature. A wire drawing machine having a well-known configuration is used for the wire drawing. The wire drawing machine is equipped with dies for subjecting the steel material to wire drawing.

[Quenching and Tempering Step (S240)]

In the quenching and tempering step (S240), the steel wire after the wire drawing step (S230) is subjected to a thermal refining treatment. The quenching and tempering step (S240) includes a quenching process and a tempering process. In the quenching process, first, the steel wire is heated to the A_{c3} transformation point or higher. For example, heating is performed using a high frequency induction heating apparatus. The heated steel wire is rapidly cooled. The rapid cooling method may be water cooling or may be oil cooling. By performing the quenching process, the microstructure of the steel wire is made a structure that is mainly composed of martensite.

The spring production step (S300) includes a cold coiling step (S310), a stress relieving treatment step (S320), a nitriding step (S330) which is performed as necessary, and a shot peening step (S340).

[Cold Coiling Step (S310)]

In the cold coiling step (S310), the steel wire produced by the steel wire preparation step (S200) is subjected to cold coiling to produce an intermediate steel material of a spring. The cold coiling is carried out using a well-known coiling apparatus. The coiling apparatus is equipped with, for example, a plurality of transfer roller sets, a wire guide, a plurality of coil forming tools (coiling pins), and a mandrel having a transverse section that is a semicircular shape. Each transfer roller set includes a pair of rollers that face each other. The plurality of transfer roller sets are arranged in a row. Each transfer roller set sandwiches the steel material between the pair of rollers and conveys the steel wire in the wire guide direction. The steel wire passes through the wire guide. The steel wire that exited from the wire guide is bent in an arc shape by the plurality of coiling pins and the mandrel and thereby formed into a coil-shaped intermediate steel material.

[Stress Relieving Treatment Step (S320)]

The stress relieving treatment step (S320) is an essential step. In the stress relieving treatment step (S320), an annealing treatment is performed in order to remove residual stress generated in the intermediate steel material by the cold coiling step (S310). The treatment temperature (annealing temperature) in the annealing treatment is set to, for example, 400 to 500° C. Although the holding time at the annealing temperature is not particularly limited, for example the holding time is 10 to 50 minutes. After the holding time passes, the intermediate steel material is allowed to cool or is slow-cooled to normal temperature.

[Nitriding Step (S330)]

The nitriding step (S330) is an optional step, and is not an essential step. That is, the nitriding step (S330) may be performed or need not be performed. In the case of performing the nitriding step (S330), nitriding is performed in the nitriding step (S330) on the intermediate steel material that has been formed in the cold coiling step (S310) and subjected to the stress relieving treatment step (S320). The term “nitriding” used herein also includes a nitrocarburizing treatment. In the nitriding, nitrogen is caused to penetrate into the outer layer of the intermediate steel material, and a nitrided layer (hardened layer) is formed at the outer layer of the intermediate steel material by solid-solution strengthening caused by solute nitrogen and precipitation strengthening caused by nitride formation.

It suffices to perform nitriding according to well-known conditions. The nitriding is performed at a treatment temperature (nitriding temperature) that is not more than the Aa transformation point. The nitriding temperature is, for example, 400 to 550° C. The holding time at the nitriding temperature is within the range of 1.0 hour to 5.0 hours. The atmosphere inside the furnace in which nitriding is performed is not particularly limited as long as the atmosphere is one in which the chemical potential of nitrogen becomes sufficiently high. The furnace atmosphere for nitriding, for example, may be made an atmosphere in which a gas with carburizing properties (RX gas or the like) is mixed as in the case of a nitrocarburizing treatment.

[Shot Peening Step (S340)]

The shot peening step (S340) is an essential step. In the shot peening step (S340), shot peening is performed on the surface of the intermediate steel material after the nitriding step (S330). By this means, compressive residual stress is imparted to the outer layer of the spring and the fatigue limit of the spring can be further increased. It suffices to perform the shot peening by a well-known method. For example, blast media having a diameter of 0.01 to 1.5 mm is used for the shot peening. The blast media is, for example, steel shot or steel beads or the like, and it suffices to utilize well-known blast media. The compressive residual stress imparted to the spring is adjusted depending on the diameter of the blast media, the shot velocity, the shot time period, and the amount of blast media shot onto a unit area per unit time.

A spring that uses the steel material of the present embodiment as a starting material is produced by the above production process.

### EXAMPLES

Hereunder, advantageous effects of the steel material of the present embodiment are described more specifically by way of examples. The conditions adopted in the following examples are one example of conditions adopted for confirming the feasibility and advantageous effects of the steel material of the present embodiment. Accordingly, the steel material of the present embodiment is not limited to this one example of conditions.

Molten steels having the chemical compositions described in Table 1 were produced.

TABLE 1

| Steel | | | | | | | | | | | | | | | | | |
|---|---|---|---|---|---|---|---|---|---|---|---|---|---|---|---|---|---|
| Type | Chemical Composition (unit is mass %; balance is Fe and impurities) | | | | | | | | | | | | | | | | |
| No. | C | Si | Mn | Cr | V | P | S | N | Mo | Nb | W | Ni | Co | B | Cu | Al | Ti |
| A | 0.61 | 2.23 | 0.70 | 1.23 | 0.10 | 0.008 | 0.008 | 0.0048 | | | | | | | | | |
| B | 0.60 | 2.15 | 0.72 | 1.17 | 0.21 | 0.007 | 0.005 | 0.0053 | | | | | | | | | |
| C | 0.63 | 2.22 | 0.68 | 1.26 | 0.57 | 0.005 | 0.009 | 0.0057 | | | | | | | | | |
| D | 0.56 | 2.64 | 0.78 | 1.53 | 0.26 | 0.006 | 0.005 | 0.0043 | 0.28 | | | | | | | | |
| E | 0.52 | 2.17 | 0.73 | 1.07 | 0.22 | 0.009 | 0.008 | 0.0047 | | 0.021 | | | | | | | |
| F | 0.62 | 2.25 | 0.71 | 1.18 | 0.18 | 0.007 | 0.007 | 0.0056 | | | 0.23 | | | | | | |
| G | 0.60 | 2.88 | 0.64 | 1.27 | 0.27 | 0.005 | 0.007 | 0.0059 | | | | 0.32 | | | | | |
| H | 0.60 | 2.18 | 0.69 | 1.86 | 0.23 | 0.009 | 0.006 | 0.0061 | | | | | 0.18 | | | | |
| I | 0.62 | 2.23 | 0.30 | 1.18 | 0.21 | 0.008 | 0.008 | 0.0051 | | | | | | 0.0037 | | | |
| J | 0.59 | 2.20 | 0.72 | 0.47 | 0.24 | 0.008 | 0.009 | 0.0058 | | | | | | | 0.032 | | |
| K | 0.76 | 1.42 | 0.68 | 0.86 | 0.19 | 0.006 | 0.007 | 0.0055 | | | | | | | | 0.0026 | |
| L | 0.61 | 2.05 | 0.64 | 1.21 | 0.23 | 0.009 | 0.008 | 0.0047 | | | | | | | | | 0.025 |
| M | 0.59 | 2.19 | 0.99 | 1.26 | 0.25 | 0.009 | 0.007 | 0.0046 | | | | | | | | | |

A blank portion in Table 1 means that the content of the corresponding element was less than the detection limit. Each of the aforementioned molten steels was used to produce a bloom by a continuous casting process. Each bloom was subjected to the roughing step (S120). Specifically, after heating the bloom, the bloom was subjected to blooming, and thereafter was subjected to rolling by a continuous mill to produce a billet in which a cross section perpendicular to the longitudinal direction was 162 mm×162 mm. The heating temperature in the roughing step (S120) was 1200 to 1250° C., and the holding time at the heating temperature was 2.0 hours.

The produced billet was subjected to the finish rolling step (S130) to produce a steel material (wire rod) having a diameter of 6.5 mm. The heating temperature in the finish rolling step (S130) was the temperature shown in the column “Heating Temperature (° C.)” of the column “Finish Rolling Step” in Table 2. The holding time at the heating temperature was 1.5 hours for each test number. The specific temperature residence time (continuous residence time within the range of 950 to 850° C.) during the finish rolling was the time shown in the column “Specific Temperature Residence Time (sec)” of the column “Finish Rolling Step” in Table 2. The rolling finishing temperature (° C.) in the finish rolling step was the temperature shown in the column “Rolling Finishing Temperature (° C.)” of the column “Finish Rolling Step” in Table 2. Note that, in the finish rolling step, the steel material temperature after the specific temperature residence time passed was, in each test number, less than the rolling finishing temperature until the finish rolling was completed.

The steel material after the completion of finish rolling was subjected to a rapid cooling treatment (RC), and subsequently was subjected to a slow cooling treatment (SC). In the rapid cooling treatment (RC), the average cooling rate when the steel material surface temperature was in the range of 950 to 800° C. was an average cooling rate (° C./sec) shown in the column “Average Cooling Rate in Rapid Cooling Treatment (° C./sec)” in Table 2. In the slow cooling treatment (SC), the average cooling rate when the steel material surface temperature was in the range of less than 800° C. to 600° C. was an average cooling rate (° C./sec) shown in the column “Average Cooling Rate in Slow Cooling Treatment (° C./sec)” in Table 2.

TABLE 2

| | | Finish Rolling Step | | | | | | | | |
|---|---|---|---|---|---|---|---|---|---|---|
| | | | | | Average | Average | | | Surface | |
| | | | | | Cooling | Cooling | | V-based | Deterioration | |
| | | | Specific | | Rate in | Rate in | | Precipitates | Suppression | |
| | | | Temperature | Rolling | Rapid | Slow | Pearlite | Volumetric | Evaluation | |
| | Steel | Heating | Residence | Finishing | Cooling | Cooling | Area | Number | Surface | |
| Test | Type | Temperature | Time | Temperature | Treatment | Treatment | Fraction | Density | Roughness | |
| No. | No. | (° C.) | (sec) | (° C.) | (° C./sec) | (° C./sec) | (%) | (pieces/μm³) | (μm) | Evaluation |
| 1 | A | 1149 | 24 | 976 | 52.3 | 0.82 | 96 | 17901 | 1.0 | E |
| 2 | B | 1153 | 24 | 983 | 49.2 | 0.80 | 97 | 30247 | 1.1 | E |
| 3 | C | 1250 | 25 | 970 | 49.9 | 0.93 | 94 | 70679 | 0.9 | E |
| 4 | D | 1152 | 24 | 987 | 50.8 | 0.91 | 93 | 6790 | 0.8 | E |
| 5 | E | 1150 | 24 | 971 | 47.4 | 0.87 | 92 | 36728 | 1.0 | E |
| 6 | F | 1151 | 96 | 968 | 51.7 | 0.86 | 95 | 40123 | 1.2 | E |
| 7 | G | 1148 | 24 | 974 | 50.3 | 0.91 | 95 | 26852 | 0.9 | E |
| 8 | H | 1152 | 24 | 980 | 50.8 | 1.88 | 92 | 39815 | 0.8 | E |
| 9 | I | 1151 | 25 | 968 | 52.5 | 0.83 | 95 | 28704 | 1.1 | E |
| 10 | J | 1150 | 25 | 974 | 48.1 | 0.93 | 96 | 33333 | 1.0 | E |
| 11 | K | 1147 | 24 | 962 | 52.0 | 0.86 | 98 | 22840 | 1.2 | E |
| 12 | L | 1150 | 23 | 981 | 49.6 | 0.83 | 94 | 37654 | 0.8 | E |
| 13 | M | 1152 | 26 | 978 | 50.3 | 0.84 | 95 | 34568 | 0.9 | E |
| 14 | B | 1147 | 6 | 985 | 51.0 | 0.86 | 95 | 5247 | 0.8 | E |
| 15 | B | 1150 | 24 | 976 | 1.2 | 0.91 | 96 | 4012 | 1.0 | E |
| 16 | A | 1036 | 26 | 966 | 52.7 | 0.88 | 96 | 2778 | 5.6 | NA |
| 17 | A | 1154 | 105 | 974 | 51.4 | 0.93 | 95 | 926 | 6.1 | NA |
| 18 | A | 1147 | 3 | 970 | 49.6 | 0.90 | 94 | 2469 | 5.9 | NA |
| 19 | A | 1149 | 25 | 1023 | 48.3 | 0.94 | 96 | 2160 | 6.8 | NA |
| 20 | A | 1150 | 24 | 962 | 0.9 | 0.82 | 94 | 1852 | 7.4 | NA |
| 21 | A | 1153 | 26 | 983 | 51.8 | 2.23 | 86 | 2469 | 6.3 | NA |
| 22 | D | 1034 | 24 | 972 | 49.6 | 0.84 | 93 | 2160 | 6.0 | NA |
| 23 | D | 1150 | 107 | 967 | 48.3 | 0.82 | 92 | 1235 | 5.7 | NA |
| 24 | D | 1147 | 4 | 980 | 51.2 | 0.90 | 92 | 2469 | 5.9 | NA |
| 25 | D | 1154 | 26 | 1018 | 49.0 | 0.86 | 95 | 2778 | 6.5 | NA |
| 26 | D | 1152 | 26 | 969 | 0.9 | 0.89 | 96 | 1543 | 7.2 | NA |
| 27 | D | 1148 | 25 | 974 | 50.5 | 2.18 | 84 | 1852 | 6.1 | NA |

Steel materials were produced by the production process described above.

[Evaluation Tests]

The produced steel material of each test number was subjected to a microstructure observation test, a test to measure the volumetric number density of V-based precipitates, and a test to evaluate surface deterioration after a shaving treatment.

[Microstructure Observation Test]

The area fraction (%) of pearlite in the microstructure of the steel material of each test number was measured by the following method. The steel material of each test number was cut in the wire diameter direction, and a resultant cross section (surface) was adopted as an observation surface. The observation surface was minor-polished. The mirror-polished observation surface was subjected to etching with 5% picric acid alcohol (picral etching reagent). On the etched observation surface, a position at a depth of ¼ of the diameter in the radial direction from the steel material surface (outer circumference of the observation surface) was defined as an observation visual field. Observation visual fields at 10 locations were observed using a scanning electron microscope (SEM) at a magnification of ×2000, and photographic images of the 10 observation visual fields were generated. The size of each visual field was set to 40 μm×60 μm.

Pearlite was identified based on the contrast and the morphology of the phases. The gross area (μm²) of pearlite in each visual field was determined. The ratio of the gross area of pearlite in all of the observation visual fields with respect to the gross area (24000 μm²) of all of the observation visual fields was defined as the area fraction (%) of pearlite. The determined area fraction of pearlite is shown in the column “Pearlite Area Fraction (%)” in Table 2.

[Test to Measure Volumetric Number Density of V-Based Precipitates]

The volumetric number density (pieces/μm³) of V-based precipitates having a maximum diameter of 2 to 20 nm in the steel material of each test number was measured by the following method. The steel material (wire rod) of each test number was cut in the wire diameter direction. A disk having a cross section in the wire diameter direction and a thickness of 0.5 mm in the central axis direction of the steel material was then extracted. Grinding and polishing were performed from both sides of the disk using emery paper to make the thickness of the disk 60 μm. Thereafter, a sample with a diameter of 3 mm was taken from the disc. The sample was immersed in 10% perchloric acid-glacial acetic acid solution to perform electropolishing, and a thin foil sample having a thickness of 100 nm was thus prepared.

The prepared thin foil sample was observed using a transmission electron microscope (TEM). Specifically, five locations (observation visual fields) on a surface (observation surface) in the wire diameter direction of the thin foil sample were observed at an observation magnification of ×200000 and an acceleration voltage of 200 kV. At such time, observation visual fields within ferrite in the pearlite were selected. The size of each observation visual field was set to 0.09 μm×0.09 μm.

In each observation visual field, precipitates were identified based on contrast. In addition, from among the plurality of precipitates that were identified, precipitates having a maximum diameter of 2 to 20 nm were identified. Here, a maximum line segment length in a case where an arbitrary two points at an interface between a precipitate and the parent phase were selected and all of a line segment connecting the two points was included in the relevant precipitate was taken as the maximum diameter.

The precipitates having a maximum diameter of 2 to 20 nm were recognized as being V-based precipitates. Note that, as a result of confirmation performed by the aforementioned EDS and NBD, it was confirmed that the precipitates having a maximum diameter of 2 to 20 nm were V-based precipitates.

The total number of V-based precipitates having a maximum diameter of 2 to 20 nm in the five observation visual fields was determined by the aforementioned measurement. The volumetric number density of V-based precipitates having a maximum diameter of 2 to 20 nm (pieces/μm³) was determined based on the determined total number of V-based precipitates and the total volume of the five observation visual fields. The determined volumetric number density of V-based precipitates is shown in the column “V-based Precipitates Volumetric Number Density (pieces/μm³)” in Table 2.

[Test for Evaluating Surface Deterioration after Shaving Treatment]

The steel material of each test number was subjected to the shaving treatment step. In the shaving treatment step, the shaving treatment was performed using a shaving die, and the surface of the steel material was peeled to a depth of 0.15 mm. The surface roughness of the steel material after the shaving treatment (hereunder, referred to as a “test specimen”) was measured. Specifically, a ten-point average roughness Rz defined in JIS B 0601 (2013) was determined. The evaluation length was set to a multiple of five times the sampling length (cut-off wavelength). Measurement of the ten-point average roughness Rz was conducted using a stylus type roughness meter. The measurement speed was set to 0.5 mm/sec. The measurement results are shown in the column “Surface Roughness (μm)” in Table 2. If the ten-point average roughness Rz was 5.0 μm or less, it was determined that surface deterioration of the steel material surface after the shaving treatment was sufficiently suppressed (described as “E” in the column “Evaluation” of the column “Surface Deterioration Suppression Evaluation” in Table 2). On the other hand, if the ten-point average roughness Rz was more than 5.0 μm, it was determined that surface deterioration of the steel material surface after the shaving treatment could not be sufficiently suppressed (described as “NA” in the column “Evaluation” of the column “Surface Deterioration Suppression Evaluation” in Table 2).

[Test Results]

The test results are shown in Table 2. Referring to Table 2, in Test Nos. 1 to 15 the chemical composition was appropriate, and the production process was also appropriate. Therefore, in the microstructure of the steel material of each test number, the area fraction of pearlite was 90% or more. In addition, in each of Test Nos. 1 to 15, the volumetric number density of V-based precipitates having a maximum diameter of 2 to 20 nm was 3000 to 80000 pieces/μm³. Therefore, even when the shaving treatment step was performed on each steel material of Test Nos. 1 to 15, the surface roughness of the steel material was 5.0 μm or less and thus surface deterioration after the shaving treatment could be sufficiently suppressed.

In Test Nos. 16 and 22, the heating temperature during finish rolling was too low. Consequently, the volumetric number density of V-based precipitates having a maximum diameter of 2 to 20 nm was less than 3000 pieces/μm³. As a result, the surface roughness of the steel material was more than 5.0 μm, and surface deterioration after the shaving treatment could not be sufficiently suppressed.

In Test Nos. 17 and 23, the specific temperature residence time was too long. Consequently, the volumetric number density of V-based precipitates having a maximum diameter of 2 to 20 nm was less than 3000 pieces/μm³. As a result, the surface roughness of the steel material (ten-point average roughness Rz) was more than 5.0 μm, and surface deterioration after the shaving treatment could not be sufficiently suppressed.

In Test Nos. 18 and 24, the specific temperature residence time was too short. Consequently, the volumetric number density of V-based precipitates having a maximum diameter of 2 to 20 nm was less than 3000 pieces/μm³. As a result, the surface roughness of the steel material was more than 5.0 μm, and surface deterioration after the shaving treatment could not be sufficiently suppressed.

In Test Nos. 19 and 25, the rolling finishing temperature was too high. Consequently, the volumetric number density of V-based precipitates having a maximum diameter of 2 to 20 nm was less than 3000 pieces/μm³. As a result, the surface roughness of the steel material was more than 5.0 μm, and surface deterioration after the shaving treatment could not be sufficiently suppressed.

In Test Nos. 20 and 26, the average cooling rate in the range from 950 to 800° C. in the rapid cooling treatment (RC) was too slow. Consequently, the volumetric number density of V-based precipitates having a maximum diameter of 2 to 20 nm was less than 3000 pieces/μm³. As a result, the surface roughness of the steel material was more than 5.0 μm, and surface deterioration after the shaving treatment could not be sufficiently suppressed.

In Test Nos. 21 and 27, the average cooling rate in the range from less than 800° C. to 600° C. in the slow cooling treatment (SC) was too fast. Consequently, the area fraction of pearlite was less than 90%. In addition, the volumetric number density of V-based precipitates having a maximum diameter of 2 to 20 nm was less than 3000 pieces/μm³. As a result, the surface roughness of the steel material was more than 5.0 μm, and surface deterioration after the shaving treatment could not be sufficiently suppressed.

An embodiment of the present disclosure has been described above. However, the foregoing embodiment is merely an example for implementing the present disclosure. Accordingly, the present disclosure is not limited to the above embodiment, and the above embodiment can be appropriately modified and implemented within a range that does not deviate from the gist of the present disclosure.

1. A steel material having a chemical composition consisting of, in mass %,
C: 0.50 to 0.80%,
Si: 1.20 to 2.90%,
Mn: 0.25 to 1.00%,
Cr: 0.40 to 1.90%,
V: 0.05 to 0.60%,
P: 0.020% or less,
S: 0.020% or less,
N: 0.0100% or less,
Mo: 0 to 0.50%,
Nb: 0 to 0.050%,
W: 0 to 0.60%,
Ni: 0 to 0.50%,
Co: 0 to 0.30%,
B: 0 to 0.0050%,
Cu: 0 to 0.050%,
Al: 0 to 0.0050%, and
Ti: 0 to 0.050%,
with the balance being Fe and impurities,
wherein:
in a microstructure of the steel material, an area fraction of pearlite is 90% or more; and
in ferrite in the pearlite,
a volumetric number density of V-based precipitates having a maximum diameter of 2 to 20 nm is 3000 to 80000 pieces/μm³.

2. The steel material according to claim 1, wherein:
the chemical composition contains one or more kinds selected from a group consisting of:
Mo: 0.01 to 0.50%,
Nb: 0.001 to 0.050%,
W: 0.01 to 0.60%,
Ni: 0.01 to 0.50%,
Co: 0.01 to 0.30%, and
B: 0.0001 to 0.0050%.
